(19) United States
(12) Patent Application Publication
(10) Pub. No.: US 2024/0051541 A1
(43) Pub. Date: Feb. 15, 2024

(54) ADAPTIVE OFF-ROAD DRIVING FEATURE CONTROL

(71) Applicant: FORD GLOBAL TECHNOLOGIES, LLC, Dearborn, MI (US)

(72) Inventors: Taylor Hawley, Oak Park, MI (US); Jeremy Lerner, Southfield, MI (US); Ali Abdallah, Dearborn, MI (US); Mohammad Abouali, Canton, MI (US); Scott Huggins, Novi, MI (US); Xingping Chen, Troy, MI (US); Andrew Edward Toy, Northville, MI (US)

(21) Appl. No.: 17/888,166

(22) Filed: Aug. 15, 2022

(51) Int. Cl. B60W 30/182; H04W 4/46; B60W 50/14

(52) U.S. Cl. CPC B60W 30/182; H04W 4/46; B60W 50/14; B60W 2552/00; B60W 2556/10; B60W 2540/215; B60W 2530/201; G01C 21/3461

(57) ABSTRACT

A system receives a request for course identification and determines specific vehicle off-road capabilities for a vehicle from which the request was received. The system determines, for presentation, one or more courses within a geographic area having terrain over which the vehicle can travel based on the determined capabilities and presents the one or more courses as selectable course options and receive selection of a course from the course options. Also, the system determines, for the selected course, geographic change regions where an optional vehicle feature should be engaged based on crowd-sourced data gathered for the selected course indicating that the vehicle feature is used by more than a threshold number of vehicles while traversing a travel region of the course following the change region and sends the vehicle the geographic change regions and the corresponding vehicle features.

### TECHNICAL FIELD

The illustrative embodiments generally relate to methods and apparatuses for adaptive off-road driving feature control.

### BACKGROUND

Select vehicles can be purchased with, or are configured for, highly adapted driving circumstances, such as off-road driving, snow/ice driving, etc. Off-road driving itself can even include a number of characteristics and purchasable or configurable features, such as, but not limited to, mud/sand, rock-crawl, weather-related driving, etc.

In recognition of these vehicle capabilities, courses are being developed and open for public usage. Sometimes these course include public park sections, privately owned courses, or private landowners willing to set aside a marked or unmarked set of trails for off-road travel. Drivers can find out from other drivers or from limited online notification of the presence of courses.

When driving on regular paved roads, drivers generally know that one asphalt road is similar to another, and are likely to encounter only asphalt, concrete and packed dirt or gravel surfaces. Because of the common material usage and composition, it is reasonably easy for a driver to understand vehicle mode and control settings for driving on such surfaces.

When it comes to off-road driving, courses can vary wildly, and a vehicle's capability to navigate a given course may depend significantly on feature sets and driver skill. Of course, since many off-road courses may be new to a given driver, the lack of terrain and course knowledge can prove a significant detriment, as well as a potential for a vehicle to not be properly equipped or set to run a course or portion of a course. Drivers in such circumstances may learn the hard way that their vehicle or skill was not appropriate for the course.

### SUMMARY

In a first illustrative embodiment, a system includes one or more processors configured to receive a request for course identification. The one or more processors are also configured to determine specific vehicle off-road capabilities for a vehicle from which the request was received and determine, for presentation, one or more courses within a geographic area having terrain over which the vehicle can travel based on the determined capabilities. The one or more processors are further configured to present the one or more courses as selectable course options and receive selection of a course from the course options. Also, the one or more processors are configured to determine, for the selected course, geographic change regions where an optional vehicle feature should be engaged based on crowd-sourced data gathered for the selected course indicating that the vehicle feature is used by more than a threshold number of vehicles while traversing a travel region of the course following the change region and send the vehicle the geographic change regions and the corresponding vehicle features.

In a second illustrative embodiment, a vehicle includes one or more processors configured to receive geographic data relating to a course selected by a driver indicating at least one path determined to be suitable for travel for the vehicle. The one or more processors are also configured to receive geographic locations along at least a chosen path of the at least one paths indicating optional vehicle feature engagement for each respective geographic location, for features present on the vehicle, that is recommended to occur prior to travel on terrain along the at least one path subsequent to each of the respective geographic locations. Further, the one or more processors are configured to determine that a vehicle traveling the chosen path has reached one of the geographic locations and automatically change vehicle state settings, based on reaching a given of the geographic locations, to enact the optional vehicle feature engagement corresponding to the reached given geographic location.

In a third illustrative embodiment, a vehicle includes one or more processors configured to receive geographic data relating to a course selected by a driver indicating at least one path determined to be suitable for travel for the vehicle. The one or more processors are also configured to receive geographic locations along at least a chosen path of the at least one paths indicating optional vehicle feature engagement for each respective geographic location, for features present on the vehicle, that is recommended to occur prior to travel on terrain along the at least one path subsequent to each of the respective geographic locations. Further, the one or more processors are configured to determine that a vehicle traveling the chosen path has reached one of the geographic locations and present an in-vehicle recommendation to the driver, based on reaching a given of the geographic locations, to enact the optional vehicle feature engagement corresponding to the reached given geographic location.

### BRIEF DESCRIPTION OF THE DRAWINGS

FIG. 1 shows an illustrative example of a vehicle configured for off-road travel and a course assistance system;

FIG. 2 shows an illustrative example of a course use tracking process;

FIG. 3 shows an illustrative example of a course provision process;

FIG. 4 shows an illustrative example of a control assistance process; and

FIG. 5 shows an illustrative example of a live course assistance process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments include robust data gathering and analysis for vehicles traveling off-road courses. By direct analysis of course and vehicle performance thereon, and/or analysis of vehicle performance on terrain comparable to that of a given portion of a course, the examples herein provide illustration as to how drivers can be informed of suitability of vehicles, control strategies for course-portions, and even obtain automatic control selection for traveling courses.

Drivers traveling unfamiliar courses and terrain can be advised of the suitability of their vehicle for travel, both on the terrain in general and any planned subsections, and can actively select which features are or are not to be used in this analysis—for example, a driver may prefer speed over control and may intentionally limit use of certain control features for faster travel. The analysis can accommodate this strategy and produce a set of suggestions and/or automated control changes to assist the driver with the travel plan.

Drivers can also be apprised of the course complexity relative to their own skill level, when prior driving data has been observed. Commonly traveled terrain and conditions can be noted, as well as a lack thereof, and success rates of comparable drivers (based on group analysis, for example) can indicate whether a driver is likely to have a successful run, and what considerations should be contemplated prior to and during travel to increase likelihood of success.

The illustrative embodiments can also provide live analysis and advice of upcoming terrain, so the driver does not have to remember a complex set of control changes and strategies while traveling. Active course analysis based on live data, comparable courses, driver skill, available features and other driver performances can provide real-time or near real-time insight into varied course conditions increasing likelihood of both successful traversal as well as meeting any driver secondary goals (such as speed).

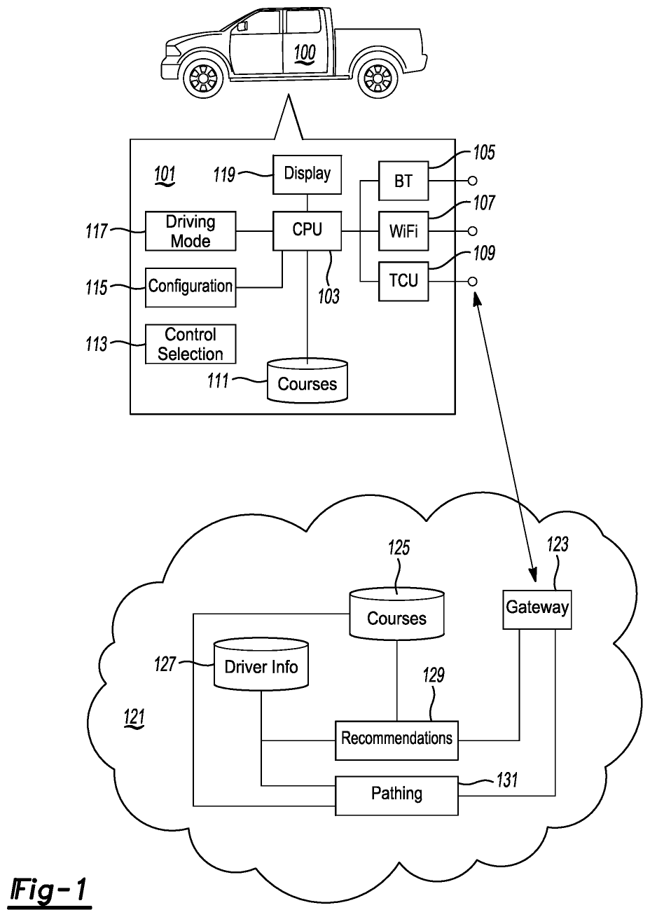

FIG. 1 shows an illustrative example of a vehicle configured for off-road travel and a course assistance system. In this example, a vehicle 100 includes an onboard computing system 101 that can be used in conjunction with the illustrative embodiments. This system 101 includes one or more processors 103, as well as a variety of communication channels. In this example, the channels include a BLUETOOTH transceiver 105, a Wi-Fi transceiver 107 and a telematics control unit 109 (TCU).

The system may also include a data store of courses 111, which can include both courses traveled by the driver and planned or proximate courses. The course data can include common terrain on a given course, challenging terrain, features recommended or necessary to travel aspects of a given course, past driver performance on a course, driver features used on a course, etc.

Driver feature usage on courses—records of which settings and systems a driver used when traveling various off-road courses—can also be used to recommend or confirm future vehicle purchases. A driver who commonly uses X, Y and Z features may want to ensure those features are available, or comparable or better features are available, on any planned future purchase that will be used for similar off-road travel.

The vehicle computing system 101 may also include a control selection/recommendation process 113. This process can work with an analysis of a course or upcoming course segment to determine what feature sets are usable, useful and/or should be used. This process can present recommendations for feature engagement and/or automatically control feature engagement to allow the driver to continue to focus on driving. Some drivers may want manual control over features, however, so automatic control does not have to be mandatory. When automatic control is instituted, it can be preplanned based on proximity to certain course features where a given vehicle feature would be useful, so that limited-use features may be engaged when useful or necessary, but may generally remain disengaged, as there is often a performance or fuel price associated with using such features.

A configuration process 115 can store the various configurations planned by an analysis of the course, and usable by the control selection and recommendation process as each portion of a course is approached or reached. This process may also be used to fixed set any features to be used for a whole course, or disable or block usage or suggestion of certain features if a driver does not want to use those features while on a course. Similarly, a driving mode process 117 can define various vehicle driving modes for use on whole or portions of courses, control mode selection, allow for disabling certain modes or mandating certain modes, and generally work to control driving mode usage. A vehicle display 119 may be used to suggest mode changes to a driver. The same mode changes can be echoed through vehicle audio. The display may also show upcoming course changes (live or virtual views). Course views may have guidance overlaid thereon, so that a view of upcoming terrain may show where a driver should or should not go, what settings to use, and may even color code the terrain to suggest difficulty levels based on vehicle capabilities, driver skill and general difficulty. In addition to changing driving modes, which may include a set of vehicle changes corresponding to travel on a certain terrain type or under certain weather conditions, users may be able to engage select vehicle aftermarket addons and/or individual changes (traction control settings, suspension settings, etc.) to create a more customized experience.

The vehicle 100 may also in communication with a backend suit in the cloud 121. This communication can be facilitated through an original equipment manufacturer gateway process 123, which may handle routing of various incoming requests and outgoing responses. In this example, the gateway may provide access to two processes at least, a recommendations process 129 and a pathing process 131.

The recommendations process 129 may provide course recommendation based on use of course 125 and driver 127 data stores. The course data stores may store course data, current conditions, terrain types, features needed to traverse, alerts, successful journeys, etc. The driver data stores may store specific driver and vehicle data, both indicating capabilities of given vehicles, courses vehicles and drivers have traveled, driver vehicle usage and course experiences, etc. The recommendation process may also provide data for one or more paths over a larger course, the paths chosen to, for example, match a vehicle capability and driver skill level. There may be other possible paths, but the recommendation process may recommend a certain geographic path that is suitable for that driver using that vehicle. This data can be used to help navigate the correct path over a course.

The recommendations process can use the data stores to recommend certain courses that meet driver skill levels and/or vehicle capabilities. This can also be used to find challenging courses and or determine that a course may be unsuitable based on skill or vehicle features.

Pathing process 131 may be used when a course is selected to determine possible or selected routes through the course. This can also include modeling portions of the course requiring skill to traverse, including feature analysis (features used by the same or other drivers to traverse those sections), speed analysis, path analysis, etc. This process can provide a set of control instructions and/or recommendations, as well as a ghost vehicle to be displayed in vehicle 100, which represents a phantom vehicle traveling over at least certain sections in a correct or recommended manner. This process can provide segment overlays for live or virtual views of upcoming terrain, to provide visual guidance as to where to go or not to go, as well as skills or features needed to travel over certain sections.

Crowdsourced data may include data from a variety of vehicles having successfully traveled a course or portion of a course. The suitability of this data's use in analysis of a given vehicle may be determined based on comparison of vehicle dimensions, model, class, etc. For example, vehicles may be classified by weight, wheelbase, dimensions, etc. and this may be used to compare a given vehicle to a subset of similar vehicles that have successfully navigated some terrain of interest to the driver of the given vehicle. In other instances, the driver may want only vehicles of the same model, or having comparable optional features, or comparable optional features as defined by a given original equipment manufacturer (OEM), etc. Weather conditions and course conditions may be other factors for comparison, wherein a driver only wants data for prior successful course runs from vehicles of, for example, the same weight (within a threshold), the same wheelbase (within a threshold) and obtained while those vehicles were traveling the course under weather conditions similar to the conditions of the day of planned travel.

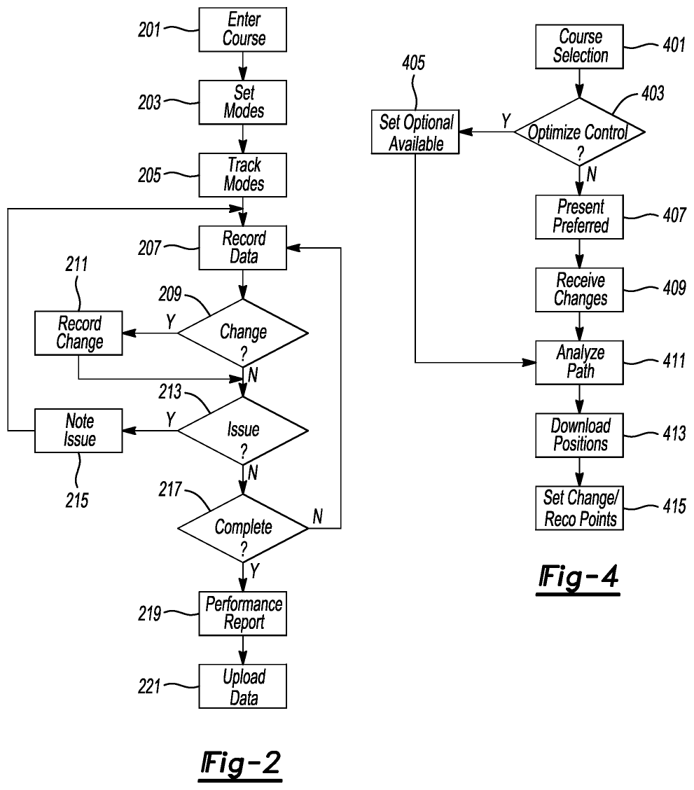

FIG. 2 shows an illustrative example of a course use tracking process. This process is an example of how the system can track travel data over an off-road course. The tracked data can be used to increase the driver's own performance, as well as the performance of any number of other vehicles and drivers. Driver times, physics changes (yaw, pitch, roll, speed changes, etc.) can be used to provide recommendations and gauge skill of the driver and other drivers relative to the given driver. Feature settings and usage can be recorded to determine what features are commonly used for certain terrain, and can be compared against driver statistics to analyze what positive or negative changes are likely produced by usage of certain features.

This process determines when a vehicle enters a course at 201. That could be expressly indicated by a driver, or could result from a geographic coordinate location of the vehicle corresponding to a location of the course or on the course. This could also be triggered by a vehicle passing through a geofence surrounding a course.

In response to entering the course, the vehicle 100 can automatically set one or more modes for travel at 203. This can include modes selected and configured by the driver in advance planning, modes recommended by the backend or modes selected at that moment by the driver. Mode usage and changes are tracked throughout the course travel at 205, to build a profile of what driving was achieved under what mode conditions. Data about driving conditions, achievements, vehicle alerts, times, sensor data, etc. is recorded as the vehicle travels at 207.

For example, a driver may engage an enhanced suspension mode for initial travel across a bumpy but level field. Then the driver may engage a high torque mode for climbing some terrain. The vehicle's sensed reactions to the travel under various modes, as well as speeds, handling parameters, etc. can be tracked across the terrain as the vehicle travels, to build a profile usable for that driver and for other drivers to understand what modes might be worth using or might be strictly necessary for successful travel.

Each time there is a change to vehicle feature settings or control settings at 209, the process can record the change at 211, as well as a location of the change and any change in driving results resulting from the change. This data can be aggregate to determine geographic coordinates or fenced areas where a mode change is recommended or should be automatically enacted.

Any issues that arise (excessive yaw, pitch, roll, excessive slippage, etc.) at 213 can also be recorded at 215, along with corresponding data (locations, terrain types, weather conditions, etc.). Whether these issues arise for all vehicles, or only vehicles of certain models and/or under certain mode settings can also be determined based on group information gathered for multiple vehicles. Data gathering can continue until the travel is completed at 217.

Once travel is complete, the vehicle 100 or a cloud process can produce a performance report at 219, detailing timing, diagnostic codes identified, mode usage, etc. The vehicle 100 could recommend changes for future travel across the course at this point, or could save that analysis for later planned travel. The data can also be uploaded to the cloud at 221 for use in assisting the driver in the future and assisting other drivers.

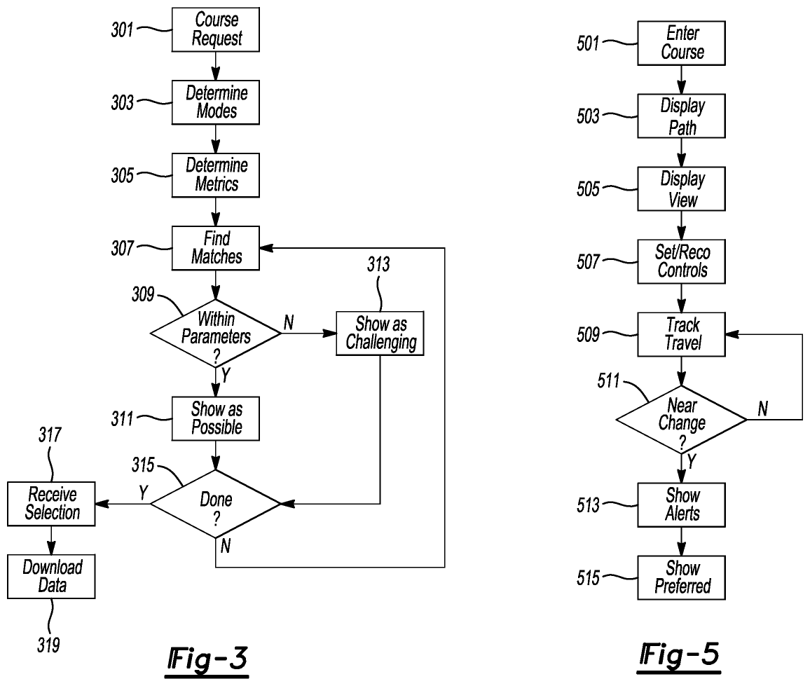

FIG. 3 shows an illustrative example of a course provision process. In this example, a driver requests a course at 301, which can include a specific course request, a request for a course having one or more specific parameters (e.g., mud), a course similar to previous courses, but yet-untraveled, etc. The vehicle can then responsively determine what modes and features are available for usage at 303, which can include any driver express restrictions or permissions about which modes are not or are to be used.

The vehicle may also consider driver metrics at 305, which can include times, grades of terrain traveled, types of terrain traveled, etc. This is an aspect of driver performance that can affect course selection. Possible courses may have driver levels associated therewith, as well as terrain types, vehicle models successfully or unsuccessfully traveling the course, modes and features used or needed to travel the course with success, etc. The process will attempt to match the vehicle and driver to one or more possible courses within a defined proximity at 307.

If a course is within driver parameters for features, modes and skill, for example, at 309, the process may identify the course as a possible course at 311. If the course is theoretically traversable based on vehicle characteristics, but includes skill challenges or is under weather conditions making traversal challenging, the process may identify the course as challenging at 313. This allows the driver to select an easier or more difficult course based on their preferences at the time. Matching can continue until the driver selects a course or all matching courses within a searchable radius are discovered and recommended at 315.

Once course analysis is completed (a process than can occur onboard, in the cloud or in a combination of both, with the vehicle analyzing known courses and the cloud providing alternatives and more recent data with respect to other drivers), the driver can select at course at 317 and the vehicle 100 can download data for the course at 319.

Since the vehicle 100 may lack updated crowdsourced data on the chosen course, the vehicle 100 may download more recent data about successful runs and feature usage for the course. The vehicle may also download an updated set of recommended control/mode/feature/setting usage and can use that data, along with driver profile data for preferred usages, to determine the likely best modes for that driver on that course.

FIG. 4 shows an illustrative example of a control assistance process. Once a driver has selected a course at 401, the driver can also choose to optimize control/feature/mode/etc. usage for the course at 403. This entails using the recommended features/modes/controls, as determined based on aggregate driver analysis or individual driver analysis. The driver may determine that the modes should be based on their own experience, if sufficient, or based on crowd-successes, or successes from a limited subset of the crowd, such as those with comparable experience, skill and/or vehicle types.

The process can set an optimal set of feature and mode controls at 405, based on computer analysis of what the vehicle “should” be using at given points along the course. These changes can be linked to geographic locations or fences around the course, and reaching those locations can trigger automatic changes and/or recommendations for the driver to manually change settings.

Alternatively, the driver may want to eschew or require certain mode usage different from the optimal set at 403. If the driver selects this option, the driver can be shown what modes, features and settings are proposed for usage on the course at 405. This may even include pros and cons of using a given change, such as “increased torque, lower speeds” or other useful information. The driver can use inherent knowledge and the identified pros and cons to determine whether certain changes should be used or not.

The driver can input express changes to settings at 407, dictating setting usage or setting prevention for a planned run over a course. This can be stored with the corresponding change points, and when the driver reaches a point where a change would have occurred, the change or recommendation may not occur and/or the driver may be told of the recommendation in a manner that also indicates that the driver has decided to likely forego this change.

The process may also analyze a planned path or upcoming path portion at 411 for change implementation. This can be part of a display of the path (live from a camera or in a virtual reconstruction) and the server can provide polygons at 413 that can be overlaid on the path to indicate areas of travel, areas related to certain modes, areas to circumvent, etc. As the viewpoint shifts as the vehicle travels, to indicate a relevant upcoming portion, the polygons can be overlaid on the view to provide visual indication of preferred paths and other useful data. The process can further save the configuration with respect to geographic locations along the path at 415, so that the appropriate data can be accommodated at the appropriate locations—which can include overlays, automatic changes, recommendations, alerts, etc.

FIG. 5 shows an illustrative example of a live course assistance process. In this example, the process determines that a vehicle 100 has entered a course at 501. This can be determined in a manner similar to 201 above. A vehicle display may display the path ahead at 503, which can include a live view, a digitally rendered 3D view and/or a 2D viewpoint of the path (e.g. top-down) at 505. The display can be split into windows showing more than one perspective, and selection of a given window may expand the view of that window and diminish or hide other views.

The process may also set or load the recommendations and control points at 507, for automatic reminder or control implementation as needed. As the vehicle travels, it can interpose the polygon overlays on any 3D viewpoint to show possible travel decisions and whether they comport with driver preferences and/or vehicle capabilities. For example, an increasing slope may have overlays of varying color as a slope increases, eventually reaching a color indicating likely impassible terrain. What is likely impassible may vary from vehicle to vehicle.

As the vehicle 100 tracks travel over the course at 509, the vehicle 100 may determine that the vehicle is approaching a change point indicated by geographic coordinates. Determined shifts in terrain composition, slopes, etc. may also dynamically trigger changes. For example, the vehicle may have a preset series of locations for changes to be implemented or recommended, but may also actively detect unexpected conditions or sensor data indicative of a needed change at other areas, and may automatically adapt settings to address those areas or recommend immediate changes outside of the original plan.

As the vehicle 100 approaches a change point at 511, the process may show any alerts associated with the terrain at 513, such as whether the vehicle can pass the terrain, whether the driver should slow down or speed up, whether certain modes are likely needed, whether the needed modes are expressly disabled, etc. The vehicle can further present or automatically implement a full or partial set of preferred changes at 515.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system comprising:
one or more processors configured to:
receive a request for course identification;
determine specific vehicle off-road capabilities for a vehicle from which the request was received;
determine, for presentation, one or more courses within a geographic area having terrain over which the vehicle can travel based on the determined capabilities;
present the one or more courses as selectable course options;
receive selection of a course from the course options;
determine, for the selected course, geographic change regions where an optional vehicle feature should be engaged based on crowd-sourced data gathered for the selected course indicating that the vehicle feature is used by more than a threshold number of vehicles while traversing a travel region of the course following the change region; and
send the vehicle the geographic change regions and the corresponding vehicle features.

2. The system of claim 1, wherein the geographic area is specified in the request.

3. The system of claim 1, wherein the geographic change regions include coordinates.

4. The system of claim 1, wherein the geographic change regions include geo-fenced areas.

5. The system of claim 1, wherein the one or more processors are further configured to determine a driver skill level based on previously collected data indicating what types of off-road travel a driver, driving the vehicle, has previously completed, and wherein the presented course options indicate whether each presented course matches the driver skill level based on a correspondence of terrain included in the presented course to the types of off-road travel the driver has previously completed.

6. The system of claim 1, wherein the one or more processors are further configured to determine a driver skill level based on previously collected data indicating what types of off-road travel a driver, driving the vehicle, has previously completed, and wherein the determination of courses for presentation includes determining that courses selected for presentation matches the driver skill level based on a correspondence of terrain included in the presented course to the types of off-road travel the driver has previously completed.

7. The system of claim 1, wherein the optional vehicle feature includes a driving mode predefined for the vehicle.

8. A vehicle comprising:
one or more processors configured to:
receive geographic data relating to a course selected by a driver indicating at least one path determined to be suitable for travel for the vehicle;
receive geographic locations along at least a chosen path of the at least one paths indicating optional vehicle feature engagement for each respective geographic location, for features present on the vehicle, that is recommended to occur prior to travel on terrain along the at least one path subsequent to each of the respective geographic locations;
determine that a vehicle traveling the chosen path has reached one of the geographic locations; and
automatically change vehicle state settings, based on reaching a given of the geographic locations, to enact the optional vehicle feature engagement corresponding to the reached given geographic location.

9. The vehicle of claim 8, wherein the suitability of the path is determined at least in part based on vehicle capabilities.

10. The vehicle of claim 9, wherein the suitability of the path is determined at least in part based on vehicle dimensions.

11. The vehicle of claim 10, wherein the suitability of the path is determined at least in part based on driver skill based on previously recorded driver data indicating whether the driver has successfully navigated terrain types included on the at least one path.

12. The vehicle of claim 8, wherein the vehicle features include a drive mode.

13. The vehicle of claim 8, wherein the optional vehicle feature engagement is based on crowd-sourced data for travel on the terrain along the at least one path subsequent to the respective geographic location indicating that more than a threshold number of drivers used features included in the optional vehicle feature engagement while successfully traveling the terrain.

14. The vehicle of claim 8, wherein the optional vehicle feature engagement is based on crowd-sourced data for travel on the terrain along the at least one path subsequent to the respective geographic location indicating that more than a threshold number of drivers, driving vehicles determined to be comparable to the vehicle based on predefined comparison metrics, used features included in the optional vehicle feature engagement while successfully traveling the terrain.

15. The vehicle of claim 14, wherein the predefined comparison metrics include vehicle dimensions.

16. The vehicle of claim 14, wherein the predefined comparison metrics include vehicle model.

17. The vehicle of claim 14, wherein the predefined comparison metrics include vehicle class.

18. The vehicle of claim 14, wherein the predefined comparison metrics include conditions of the terrain based at least on weather patterns.

19. A vehicle comprising:
one or more processors configured to:
receive geographic data relating to a course selected by a driver indicating at least one path determined to be suitable for travel for the vehicle;
receive geographic locations along at least a chosen path of the at least one paths indicating optional vehicle feature engagement for each respective geographic location, for features present on the vehicle, that is recommended to occur prior to travel on terrain along the at least one path subsequent to each of the respective geographic locations;
determine that a vehicle traveling the chosen path has reached one of the geographic locations; and
present an in-vehicle recommendation to the driver, based on reaching a given of the geographic locations, to enact the optional vehicle feature engagement corresponding to the reached given geographic location.

20. The vehicle of claim 19, wherein the optional vehicle feature engagement is based on crowd-sourced data for travel on the terrain along the at least one path subsequent to the respective geographic location indicating that more than a threshold number of drivers used features included in the optional vehicle feature engagement while successfully traveling the terrain.
